(19) United States
(12) Patent Application Publication
(10) Pub. No.: US 2026/0328537 A1
(43) Pub. Date: Oct. 22, 2026

(54) DIGITALLY AUGMENTED HOLOGRAPHIC WEAPON SIGHT

(71) Applicant: EOTech, LLC, Plymouth, MI (US)

(72) Inventors: Abram Summerfield, Orofino, ID (US); Brian Bellah, Orofino, ID (US)

(21) Appl. No.: 19/468,295

(22) Filed: Feb. 3, 2026

Related U.S. Application Data
(60) Provisional application No. 63/755,665, filed on Feb. 7, 2025.

(51) Int. Cl. F41G 11/00; G02B 7/182; G02B 27/01

(52) U.S. Cl. CPC F41G 11/003; G02B 7/182; G02B 27/0103; G02B 27/0149; G02B 27/0189; G02B 2027/0154

(57) ABSTRACT

A weapon sight includes a housing, an optical component carrier, a digital display device, and an adjustment assembly. The housing is configured to mount to a weapon and includes a carrier base and a frame that at least partially defines a viewing window. The optical component carrier is coupled to the carrier base for illuminating a holographic image that is visible through the viewing window. The digital display device is at least partially coupled to the carrier base for displaying a digital image that is visible through the viewing window. The holographic image and the digital image may form a combined image. The adjustment assembly may include a first adjustment member and a second adjustment member configured for positional adjustment of the combined image in the viewing window and to receive a force to drive movement of the carrier base about a sighting axis.

### CROSS-REFERENCE TO RELATED APPLICATION

This application claims the benefit and priority under 35 U.S.C. §119(e) of U.S. provisional application Ser. No. 63/755,665, filed on Feb. 7, 2025, the content of which is incorporated herein by reference in its entirety.

### TECHNICAL FIELD

The present disclosure relates generally to weapon sights, and more specifically to digitally augmented holographic weapon sights combining holographic and digital imaging technologies, assemblies, subassemblies, and associated components thereof.

### BACKGROUND

Weapon sights are utilized to assist a weapon operator in locating and aiming a weapon at a target. Conventional optical sights often use holographic optics that, when viewed through an optical window, illuminate a holographic image of a reticle at a distance in the field of view. It is also known to position a digital camera or other digital optical device in front of the optical sight, such that the reticle image is superimposed in the field of view imaged by the optical device.

Separately mounting digital and holographic devices on a weapon presents significant technical challenges. For example, independently mounted devices may experience misalignment from manufacturing tolerances, differential thermal expansion, and recoil-induced stress, causing the optical axes to diverge and creating spatial offset between the holographic reticle and digital information. As another example, non-integrated systems can create parallax errors because the digital image and holographic reticle originate from different focal planes, causing their apparent relative positions to shift when the operator's eye position changes. Further, conventional windage and elevation adjustments may be limited to only moving the holographic optical components, leaving the digital display stationary and causing misalignment between the reticle and digital information during sighting adjustments.

It would be beneficial to have a holographic sight that is integrated with a digital optical device, where both imaging systems are rigidly coupled to a common carrier structure such that adjustments move both optical systems in unison while maintaining precise alignment, and where both images project onto a common focal plane to reduce parallax errors.

### SUMMARY

The present disclosure addresses the foregoing challenges by providing a weapon sight in which both a holographic reticle system and a digital display system are rigidly mounted to a common carrier base at least partially within an integrated housing. This structural integration ensures that windage and elevation adjustments, which move the carrier base relative to the weapon mounting interface, simultaneously displace both optical systems while maintaining their fixed spatial relationship. Furthermore, the optical design projects both the holographic image and the digital image onto a common focal plane at the viewing window, eliminating parallax errors and ensuring consistent image alignment regardless of operator eye position. Accordingly, the weapon sight may integrate both holographic and digital display technologies to enhance targeting and operator capabilities.

According to an aspect of the disclosure, a weapon sight includes a housing, an optical component carrier, a digital display device, and an adjustment assembly. The housing has a base that is configured to adjustably mount to a weapon. The optical component carrier is fixedly attached to the housing for illuminating a holographic image that is visible through a viewing window disposed over the base of the housing. The digital display device is fixedly attached to the housing for displaying a digital image that is also visible through the viewing window simultaneously with the holographic image. The weapon sight includes an adjustment assembly between the base and the weapon for positional adjustment of the housing about a sighting axis. Movement of the housing about the sighting axis relative to the weapon via the adjustment assembly simultaneously moves both the optical component carrier and the digital display device to maintain a fixed spatial relationship between the holographic image and the digital image. The weapon sight, in some implementations, includes a first adjustment member and a second adjustment member that are operable to receive a force to each drive movement of the housing about the sighting axis, such as elevation and windage adjustments.

According to another aspect of the disclosure, a weapon sight includes a housing having a base configured to mount to a receiver of a weapon. A frame disposed above the base of the housing defines a viewing window of the weapon sight. An optical component carrier is coupled to the housing and fixedly supports a plurality of optical components that are operable to illuminate a holographic image that is visible through the viewing window along a first optical path. A digital display device is also coupled to the housing and is operable to display a digital image visible through the viewing window along a second optical path. The holographic image and the digital image are simultaneously visible in the viewing window. An adjustment assembly is coupled to the housing and is configured to adjustably move the housing relative to the weapon about a sighting axis defined by the adjustment assembly. The first optical path and the second optical path remain fixed relative to each other when adjustably moving the housing about the sighting axis relative to the weapon.

In some implementations, a frame at least partially defines the viewing window, such as in some examples where the frame includes an upper portion of the housing. In some aspects, the base of the housing includes a first mounting portion supporting the optical component carrier and a second mounting portion supporting the digital display device. In some cases, the housing includes a monolithic structure to which both the optical component carrier and the digital display device are directly attached. The holographic image and digital image, in some examples, share a common optical axis that remains substantially fixed upon movement of the housing about the sighting axis.

The sighting axis, in some implementations, includes a rotational axis, such that the first adjustment member may be configured to receive force to drive movement of the housing about the rotational axis relative to the weapon. The first adjustment member, in some examples, is coupled to the housing by a fastener defining the rotational axis, such that where the first adjustment member includes a linear adjustment mechanism engaged with the housing at a spaced distance from the rotational axis and operable to drive movement tangential to the rotational axis to impart rotational movement of the housing about the rotational axis. In some examples, the first adjustment member includes a first adjuster having a projection configured to engage with the housing at a spaced longitudinal distance on the weapon from the rotational axis. The adjuster may be configured to linearly move the projection in a direction transverse to the longitudinal axis of the weapon, where the linear movement of the projection is configured to impart rotational movement of the housing about the rotational axis within a rotational range.

In some implementations, the second adjustment member includes a flexure portion disposed between opposing end portions of the second adjustment member, where the flexure portion defines a flexure axis. The sighting axis, in some examples, includes the flexure axis, such that the second adjustment member is configured to receive force to drive movement of the second mounting portion about the flexure axis. For instance, a first end portion of the second adjustment member is attached to the housing with fasteners, such that a second end portion of the second adjustment member includes an elevation adjustment mechanism at a spaced distance from the flexure axis and operable to drive vertical movement of the housing about the flexure axis. In some implementations, the second end portion includes a second adjuster having a wedge configured to engage with the housing at a spaced longitudinal distance on the weapon from the flexure axis. The second adjuster is configured to linearly move the wedge to drive vertical movement of the housing about the flexure axis. In some examples, the second adjuster includes a threaded shaft that is threadably engaged by the wedge, in a slot defined in the second adjustment member, and rotation limits of the threaded shaft define the vertical adjustment range of the housing.

In some implementations, the optical component carrier includes a rigid chassis defining an optical window and a plurality of mating surfaces configured to support optical components for illuminating the holographic image in the optical window, such that the optical window is aligned with the viewing window of the housing. The optical components may include a light source, a collimating optic, a mirror, a diffraction grating, and an image hologram. In some examples, the chassis of the optical component carrier has a metal sheet that is formed to define the optical window and the plurality of mating surfaces configured to support optical components. The optical component carrier may form a first optical path from the light source to each of the optical components and to the viewing window that is uninterrupted for viewing the holographic image in the viewing window.

In some implementations, the digital display device includes a display and a beam splitter for displaying the digital image in the viewing window. The digital display device, in some examples, forms a second optical path from the display engine to the viewing window that is uninterrupted. These aspects and implementations provide a comprehensive and versatile targeting solution by combining the advantages of holographic sighting with digital augmentation.

Implementations of the disclosure may include one or more of the preceding features in various combinations. The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is a rear perspective view of a weapon sight mounted on a weapon.

FIG. 2 is an upper, rear perspective view of the weapon sight of FIG. 1.

FIG. 3 is a side view of the weapon sight of FIG. 1.

FIG. 4 is a side view of the weapon sight of FIG. 1.

FIG. 5 is a top view of the weapon sight of FIG. 1.

FIG. 6 is a front view of the weapon sight of FIG. 1.

FIG. 7 is a rear, user view of the weapon sight of FIG. 1.

FIG. 8 is a cross-sectional side view of the weapon sight of FIG. 1.

FIG. 9 is a top, rear perspective view of an adjustment assembly.

FIG. 10 is a bottom, rear perspective view of the adjustment assembly of FIG. 9.

FIG. 11 is a top view of the adjustment assembly of FIG. 9.

FIG. 12 is a side view of the adjustment assembly of FIG. 9.

FIG. 13 is an exploded side view of the adjustment assembly of FIG. 9.

FIG. 14 is an exploded perspective view of the adjustment assembly of FIG. 9.

FIG. 15 is a rear perspective view of the weapon sight with an upper portion removed.

FIG. 16 is a top view of the weapon sight of FIG. 15.

FIG. 17 is a rear perspective view of an optical component carrier.

FIG. 18 is a top view of the optical component carrier of FIG. 17.

FIG. 19 is a front perspective view of the optical component carrier of FIG. 17.

FIG. 20 is a cross-sectional side view of the optical component carrier of FIG. 17.

FIG. 21 is a rear perspective view of an exemplary battery module.

Like reference numerals indicate like parts throughout the drawings.

### DETAILED DESCRIPTION

Referring now to the drawings and illustrative examples depicted therein, a weapon sight is disclosed that integrates holographic and digital display technologies within a unified housing structure to provide simultaneous viewing of a holographic reticle and digital information. The weapon sight may be configured and adapted to be removably attached to a suitable weapon that requires aiming by an operator. For example, the weapon or weapon system may be a handheld weapon capable of shooting a projectile, including a rifle, a shotgun, a pistol, a handgun, a bow, or any other weapon commonly used in a handheld manner. The weapon sight is particularly adapted for mounting to weapon systems equipped with standardized mounting interfaces such as Picatinny rails or Weaver-style rails.

The weapon sight includes a housing that is configured to releasably engage with a corresponding mounting feature or component on the weapon, such as a Weaver or Picatinny rail. The housing provides structural support for both a holographic optical system and a digital display system, with both systems rigidly mounted to a common carrier base within the housing to maintain a fixed spatial relationship during operation and adjustment. The sight has a front end (i.e., a target-facing side) and a rear end (i.e., a user-facing side), where the longitudinal dimension of the sight is defined between the front and rear ends. An operator of the sight may look through a rear window situated on the rear end and aligned with a front window. The area visible to the operator through the rear window and aligned with the front window may be referred to as the viewing window. The housing may include a frame that is integrally or separately coupled with the carrier base of the housing to extend upward and at least partially define the viewing window and support a glass pane or lens occupying the front and rear ends of the viewing window, such that a user may see through the viewing window through the openings in the frame. The frame may also include a hood piece that extends over the frame to partially surround the optical components in the viewing window, so as to prevent damage to the viewing window and the optical components therein.

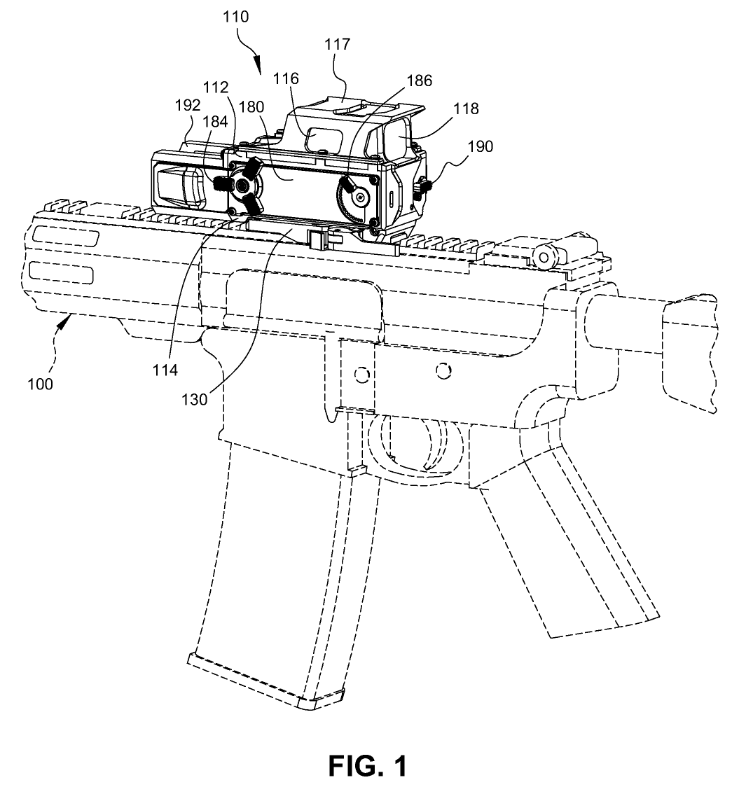

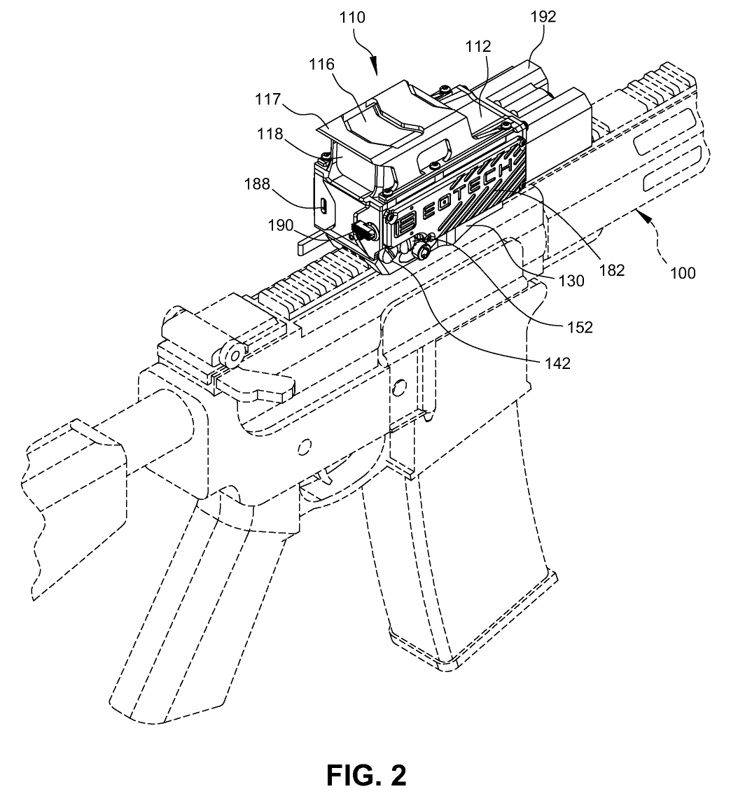

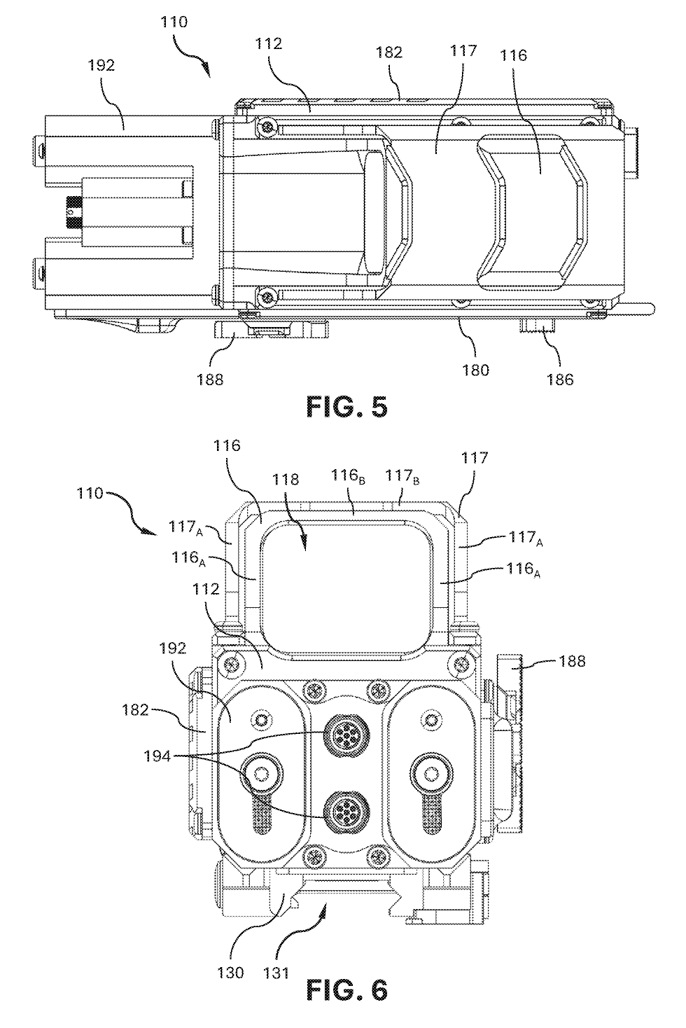

Referring to FIGS. 1-6, a weapon sight 110 is provided that is configured to be mounted to a weapon system 100. The weapon sight 110 integrates a holographic reticle with an augmented digital display to enhance the operator's targeting capabilities, situational awareness, and/or discrete access to additional information by allowing simultaneous use of both the holographic reticle and digital information displayed in the viewing window. The housing 112 of the weapon sight 110 is configured to securely mount to the weapon system, providing a stable platform for both the holographic optical components and the digital display components. The housing 112 includes a carrier base 114 (lower portion) and a frame 116 (upper portion), with the carrier base 114 providing rigid mounting surfaces for both the optical component carrier 120 and the digital display device 124. The housing 112 is designed to protect the internal components from environmental factors while maintaining precise alignment and functionality of both optical systems. The structural integration of both optical systems within the housing 112 ensures that any movement of the housing relative to the weapon, such as during windage and elevation adjustments, moves both systems simultaneously while preserving their fixed spatial relationship.

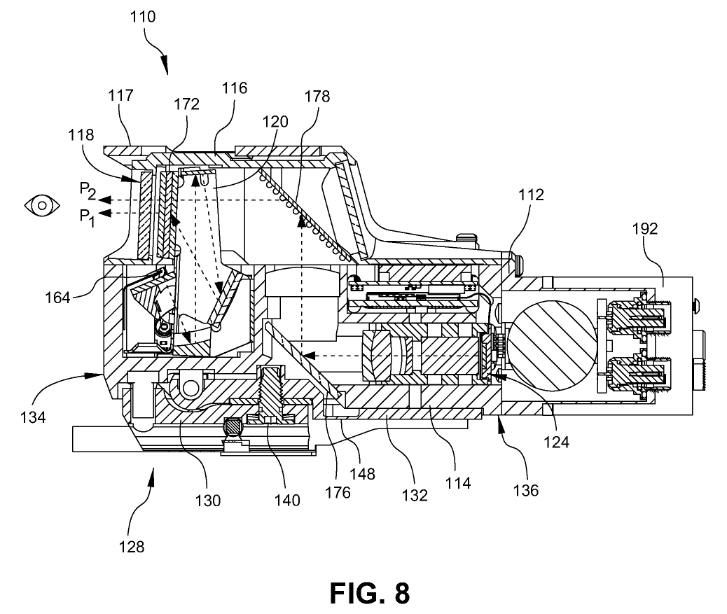

The lower portion of the housing 112 is referred to as a base or a carrier base 114, which has internal carrier surfaces for securely mounting the internal optical and display components. The carrier base 114 rigidly supports both the optical component carrier 120 and the digital display device 124, facilitating the integration of the two imaging systems. Specifically, the carrier base 114 includes a first mounting portion 134 (as shown in FIG. 8) configured to receive and fixedly support the optical component carrier 120, and a second mounting portion 136 configured to receive and fixedly support the digital display device 124. The first mounting portion 134 and second mounting portion 136 are formed as integral parts of the carrier base 114 (as a monolithic structure) or are rigidly attached thereto, such that the carrier base 114 forms a unified structural platform. This unified platform design ensures that when the adjustment assembly 128 moves the carrier base 114 relative to the weapon mount (such as for windage or elevation adjustment), both the optical component carrier 120 and the digital display device 124 move together as a unit, maintaining their precise relative positioning.

The upper portion of the housing 112 includes a frame 116 that defines the viewing window through which the operator can view the combined image. This frame 116 is designed to provide a clear and unobstructed field of view, allowing the operator to quickly acquire and engage targets. In some examples, the frame may be a separate piece from the housing and may be or include a protective cover or hood feature. The integration of the holographic reticle and digital display within the same viewing window enhances situational awareness by overlaying important information directly onto the target area. The viewing window 118 defined by the frame 116 has front and rear windows in the respective front and rear openings, which are sealed about their perimeters to protect the interior of the housing 112.

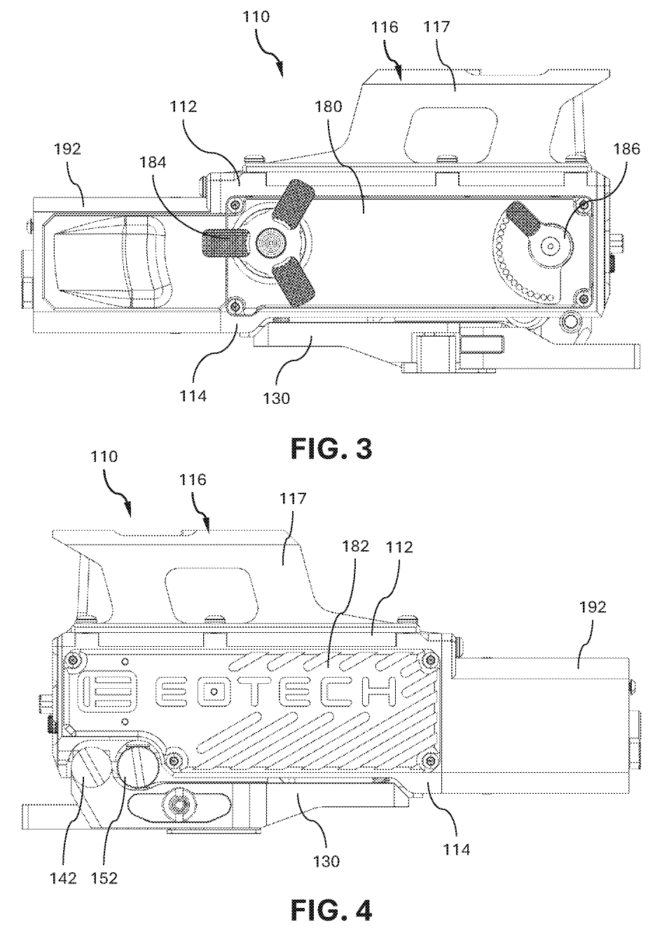

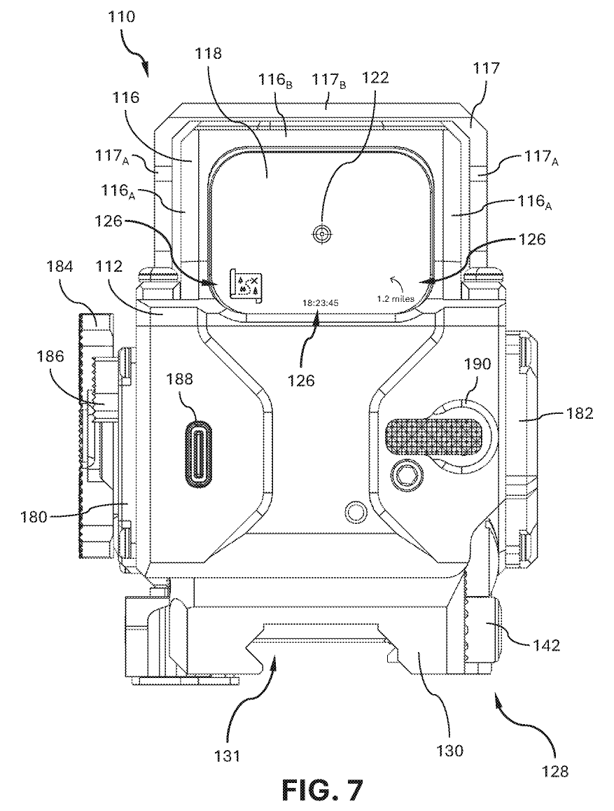

As shown in FIGS. 3 and 4, the sides of the housing 112 of the weapon sight 110 may include side panels 180, 182 that are fastened at the corners to conceal the interior of the housing 112 and provide additional protection to the interior of the weapon sight 110. The housing 112 may include a plurality of interactive buttons, toggles, switches, or knobs for operating various features of the sight, such as the holographic reticle brightness and various features of the displayed image or images. As shown in FIG. 3, the side panel 180 on the housing 112 features two rotating knobs, one knob 184 for operating the digital display, such as for menu navigation, and another knob 186 for operating the holographic image, such as brightness adjustment. As also shown in FIG. 7, the front portion of the housing 112 also includes a USB/USB-C connection port 188 for data transfer or power supply, and a toggle switch 190 for mode selection. These interactive elements allow the operator to customize and control the sight's settings efficiently, enhancing the overall user experience and functionality of the weapon sight 110. The knob 184 may control functions such as digital display brightness, contrast, information overlay selection (e.g., toggling between ballistic data, navigation information, and targeting overlays), and menu navigation for configuring display parameters. The knob 186 may control the brightness intensity of the holographic reticle 122, allowing the operator to optimize reticle visibility under varying lighting conditions ranging from bright daylight to low-light or night vision compatible settings. The toggle switch 190 may select operational modes such as daytime mode, night vision mode, or power-saving mode.

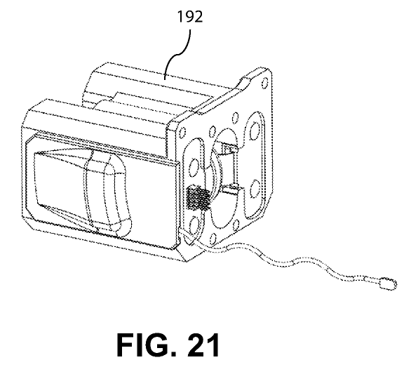

The rear side of the weapon sight 110, as shown in FIG. 6, provides a module 192 that is connected to the rear side of the housing 112, where this module is a battery module 192 that functions to power the electrical components of the weapon sight, including the light source 164 that illuminates the holographic image 122 and the imager of the display 124 that displays the digital image 126. As shown separated in FIG. 21, the module 192 may be removed, such as to be separately charged and/or replaced with a fully charged battery module. The battery module 192 may also include connection ports 194 at a rear side thereof, such as for connecting to other weapon accessories, such as lasers, lights, and the like.

As shown in FIG. 7, the frame 116 partially defines the viewing window 118, through which the operator can view the combined image. Specifically, the frame 116 includes leg sections 116_{A} that protrude upward from the opposing sides of the central portion of the housing 112 and an upper section 116_{B}that interconnects between the leg sections 116_{A}. Accordingly, the leg sections 116_{A}and upper section 116_{B}border three sides of a generally rectangular viewing window 118, where the central portion of the housing forms the lower border of the viewing window 118. The frame 116 shown in FIGS. 1-7 also includes a hood piece 117 that extends over the frame to partially surround the optical components in the viewing window, so as to prevent damage to the viewing window and the optical components therein. Specifically, the hood piece 117 includes leg sections 117_{A}that protrude upward from the opposing sides of the central portion of the housing 112 and an upper section 117_{B}that interconnects between the leg sections 117_{A}. Accordingly, the hood piece 117 generally follows the outer surface of the frame 116 with a gap therebetween to provide impact resistance.

As further shown in FIG. 7, the holographic image 122 and digital image(s) 126 are visible within the viewing window 118, illustrating an example of how the sight integrates both a holographic reticle 122 and digital display elements 126 to enhance the operator's targeting and situational awareness. The holographic image 122 and digital image 126 are superimposed within the same field of view, forming a combined image in which both elements are simultaneously visible to the operator. Critically, because both the optical component carrier 120 generating the holographic image 122 and the digital display device 124 generating the digital image 126 are rigidly mounted to the common carrier base 114, the spatial relationship between the holographic reticle 122 and the digital display elements 126 remains fixed. This fixed relationship is maintained even when the weapon sight 110 is adjusted for windage or elevation via the adjustment assembly 128, as such adjustments move the entire carrier base 114 (and thus both optical systems) together.

The holographic reticle 122, as shown in FIG. 7, is a key feature, providing a consistent and reliable aiming point for the user. This reticle 122 is generated using holographic technology, ensuring that it remains accurately positioned within the viewing window 118, regardless of the user's position and movement. The holographic reticle 122 is visible simultaneously with the digital image 126, which can display a variety of real-time information. This digital overlay may include map data, directional indicators, and the current time, all of which are crucial for situational awareness and decision-making in the field. The digital display is designed to be easily readable and intuitive, allowing the operator to quickly interpret the information without distraction. The combination of a stable holographic reticle with dynamic digital information offers a comprehensive solution for operators, improving accuracy, efficiency, and situational awareness in various operational scenarios.

The integrated design eliminates parallax errors that would otherwise occur in non-integrated systems where digital and holographic images originate from different focal planes. In the present weapon sight 110, both the holographic optical path and the digital display optical path are designed to converge at the viewing window 118, presenting both images at a common focal plane. This optical design ensures that the apparent relative position of the holographic reticle 122 and digital image elements 126 remains constant regardless of the operator's eye position behind the sight, allowing for rapid target acquisition without requiring precise head positioning.

FIG. 8 shows a cutaway side view of the weapon sight 110, schematically illustrating the optical paths P₁, P₂ of the holographic imaging system and the digital display system, respectively. Both optical paths converge at the viewing window 118 to present a combined image to the operator. The optical component carrier 120 is fixed to the first mounting portion 134 within the housing 112, supporting the light source 164 and the image hologram 172, among other optical components. The light source 164 emits light that travels through the optical path P₁, interacting with the hologram 172 to produce a holographic image. This image is then directed through the optical window 116, which is aligned with the viewing window 118, allowing the user to view the holographic reticle.

The holographic imaging system comprises a light source 164, a collimating optic 166, a mirror 168, a diffraction grating 170, and an image hologram 172. The light source 164, which may be a light-emitting diode (LE may be a light-emitting diode (LED) or laser diode operating at a specific wavelength (e.g., red laser at approximately 632-650 nm), generates a light beam that travels along the first optical path P1. The collimating optic 166 receives the light beam from the light source 164 and directs collimated light (i.e., light rays that are substantially parallel) toward the mirror 168. The mirror 168 reflects the collimated light toward the diffraction grating 170, which diffracts the light and directs it toward the image hologram 172. The image hologram 172 is a holographic optical element (HOE) that has been recorded with the desired reticle pattern (e.g., a circular dot, crosshair, or other aiming pattern). When illuminated by the diffracted light from the diffraction grating 170, the image hologram 172 reconstructs the holographic image 122, which appears to the operator as a reticle pattern suspended in space within the viewing window 118. The first optical path P1 extends from the light source 164, through each of these optical components, and terminates at the viewing window 118 where it is visible to the operator's eye. The optical component carrier 120 secures the optical components in the intended relative positions, including distance and orientation, relative to each other, as even small variances from the intended position of even one of the optical components may negatively impact the generation of a hologram for use by the operator of the sight 110.

Still referring to FIG. 8, the digital display 124 is positioned within the housing 112 and is responsible for generating digital images that are superimposed with the holographic image 122 to form the combined image visible in the viewing window 118. The digital display device 124 includes an imager 174 (which may be an OLED display, LCD display, LCOS microdisplay, or other suitable display technology), a mirror 176, and a beam splitter 178. The imager 174 generates the digital image 126, which may include alphanumeric data, graphical overlays, targeting information, ballistic corrections, navigation data, or other information relevant to weapon operation. Light from the imager 174 travels along the second optical path P2, first reflecting off the mirror 176 and then passing through or reflecting from the beam splitter 178. These components guide the digital image along a second optical path P₂, ensuring alignment with the holographic image 122 at the viewing window 118.

The beam splitter 178 is positioned within the housing 112 at a location where it can receive light from both the first optical path P1 (holographic image) and the second optical path P2 (digital image). In one implementation, the beam splitter 178 is positioned such that the holographic image light from path P1 passes through the beam splitter 178 with minimal attenuation, while the digital image light from path P2 is reflected by the beam splitter 178 along the same axis. This optical configuration causes both images to be coaxially aligned and directed toward the viewing window 118, where they appear superimposed to the operator. The beam splitter 178 functions to combine the two optical paths P1, P2 such that both the holographic image 122 and the digital image 126 are simultaneously visible through the viewing window 118 with a fixed spatial relationship.

The imager 174 is fixedly attached in the second mounting portion 136 of the carrier base 114, while the optical component carrier 120 is fixedly attached to the first mounting portion 134 of the carrier base 114. Because both mounting portions 134, 136 are part of the unified carrier base 114 structure, the optical component carrier 120 and the digital display device 124 are maintained in a fixed spatial relationship to each other. This rigid coupling ensures that the first optical path P1 and the second optical path P2 maintain their relative alignment, such that the holographic image 122 and digital image 126 remain properly superimposed within the viewing window 118 regardless of environmental conditions, weapon recoil, or adjustment of the sight via the adjustment assembly 128.

To adjust the windage and elevation of the sight 110 and effectively zero the sight on the attached weapon system, an adjustment assembly 128 is coupled between the carrier base 114 of the housing 112 and the mounting interface on the weapon. The adjustment assembly 128 enables precise angular positioning of the carrier base 114 (and thus the entire combined optical system) relative to the weapon's bore axis, allowing the operator to align the holographic reticle 122 with the weapon's point of impact at a selected range. Critically, because both the optical component carrier 120 and the digital display device 124 are rigidly mounted to the carrier base 114, adjustment of the carrier base 114 via the adjustment assembly 128 moves both optical systems simultaneously, maintaining the fixed spatial relationship between the holographic image 122 and the digital image 126 throughout the adjustment process.

As shown in FIG. 8, the adjustment assembly 128 includes a first adjustment member 130 and a second adjustment member 132, which facilitate the precise alignment of the combined image. In this example, the first adjustment member 132 is directly attached to the weapon and the second adjustment member 132 is directly attached to the carrier base 114 of the housing 112. Specifically, the first adjustment member 130 has a lower channel 131 (FIG. 16) that is configured to releasably engage with corresponding components on a firearm, such as a Picatinny rail, Weaver rail, or the like, in order to secure the weapon sight 110 to the firearm. As shown, the lower channel 131 is configured to slidably engage the rail and a pin spans the channel and engages a lateral slot on the rail. The pin may include a lever that can function to clamp closed to lock the pin and release to threadably remove the pin. The second adjustment member 130 is directly attached to the carrier base 114 of the housing 112 with fasteners that extend through the end plate and into the carrier base 114.

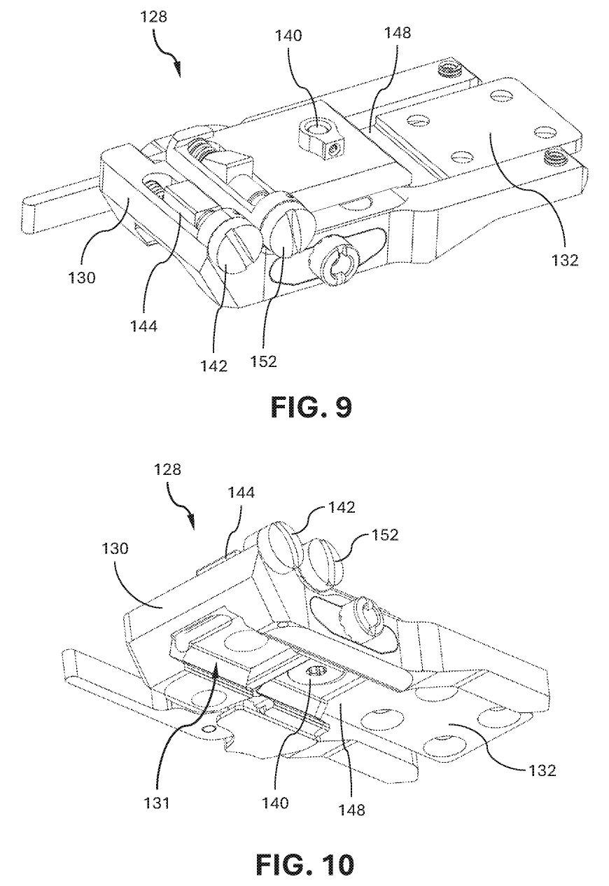

As shown in FIGS. 9-14, the housing 112 is detached and removed from the adjustment assembly 128, showing the first adjustment member 130 and the second adjustment member 132. The first and second adjustment members 130, 132 of the adjustment assembly 128 are configured for positional adjustment of the housing about a sighting axis to adjust the position of the combined image in the viewing window relative to the weapon. The adjustment assembly 128 allows for precise sighting of the weapon sight 110 on the weapon by alignment and positioning of the combined holographic and digital images within the viewing window. This assembly 128 is designed to maintain the stability and accuracy of the image alignment, irrespective of the user's movements, external impacts to the weapon or the weapon sight, or environmental changes.

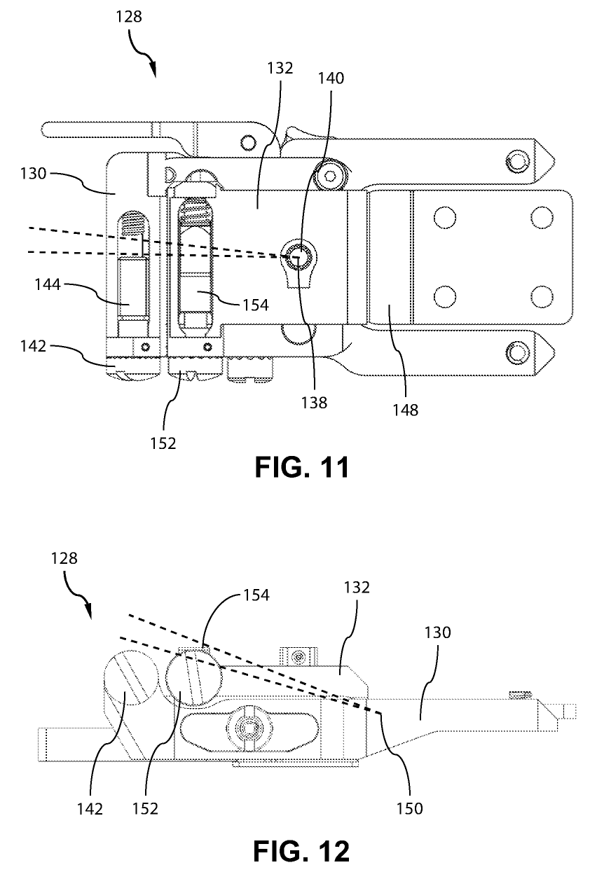

In the illustrated example, the first adjustment member 130 is configured to provide windage adjustment (horizontal or lateral adjustment) by rotating the carrier base 114 about a rotational axis 138 (FIG. 11). The rotational axis 138 extends generally vertically through the weapon sight 110 when the sight is mounted to a weapon in normal operating orientation. Specifically, the first adjustment member 130 is coupled to the second adjustment member 132 by a fastener 140 defining the rotational axis 138; therefore, the first adjustment member 130 is indirectly attached to the housing by the fastener 140. The first adjustment member 130 is configured to receive force to drive movement of the carrier base 114, and in turn the entire housing, about the rotational axis 138 to provide the windage adjustment.

As shown in FIG. 14, the first adjustment member 130 has a front end with a U-shaped mounting bracket and a rear end with an upward-facing slot that exposes a threaded bore. The threaded bore receives a threaded shaft of a first adjuster 142. The first adjuster 142 includes a projection 144 (which may be a pin, button, or other protruding element) that extends upward from the threaded shaft and is disposed within the upward-facing slot. The projection 144 is positioned to engage a corresponding surface on the underside of the carrier base 114 or the second adjustment member 132, such that the projection 144 can apply lateral force to the carrier base 114. As such, rotation limits of the threaded shaft may define the degree of lateral movement of the projection along the slot, which corresponds to the imparted rotational range α (FIG. 11) of the housing about the rotational axis 138. The projection 144 is configured to engage with the housing at a spaced longitudinal distance on the weapon from the rotational axis 138, wherein the adjuster 142 is configured to linearly move the projection 144 in a direction transverse to the longitudinal axis of the weapon. The linear movement of the projection 144 is configured to impart rotational movement of the housing about the rotational axis within the rotational range α, which thereby defines the range of windage adjustment.

The windage adjustment mechanism operates with the first adjustment member 130 that is coupled to the second adjustment member 132 via the fastener 140, which defines the rotational axis 138. The fastener 140 may be a pivot pin, shoulder bolt, or similar fastener that permits rotational movement while maintaining axial positioning. The first adjuster 142 is located at a distance from the rotational axis 138, such that rotation of the threaded shaft causes the projection 144 to move laterally (perpendicular to the longitudinal axis of the weapon). As the projection 144 moves laterally and tangentially to the rotational axis, it applies force to the carrier base 114 at a point spaced from the rotational axis 138. This offset force creates a moment about the rotational axis 138, causing the carrier base 114 (along with the second adjustment member 132 to which it is attached) to rotate about the axis 138. The range of lateral movement of the projection 144 is limited by the length of the slot in which it travels, and by the threaded engagement length of the first adjuster 142. Rotation limits of the threaded shaft define the maximum lateral displacement of the projection 144, which in turn defines the rotational range α (FIG. 11) available for windage adjustment.

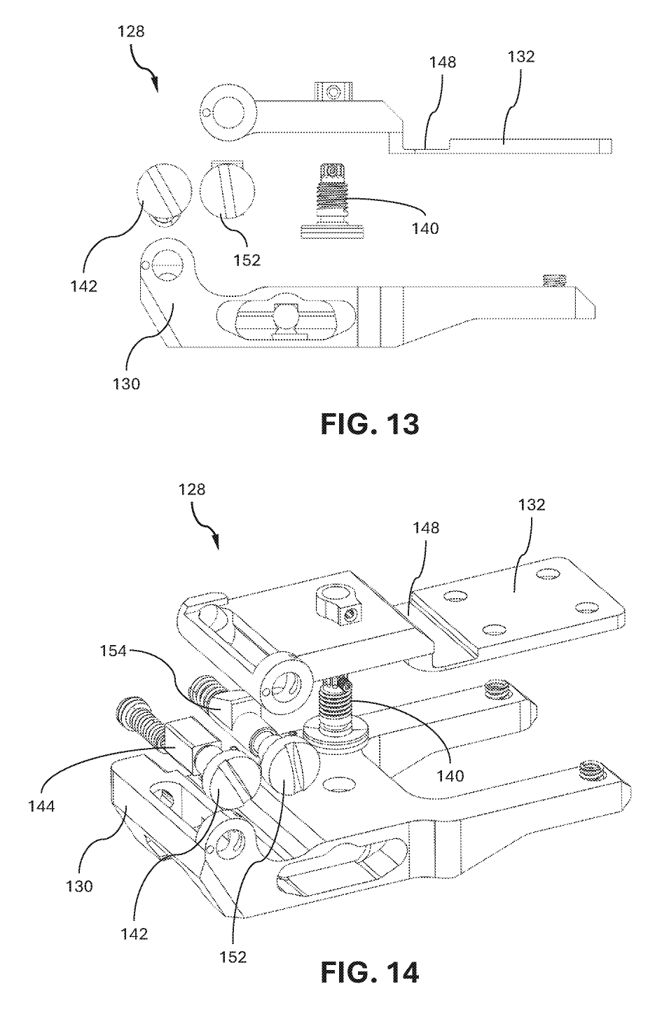

As further shown in FIGS. 9-14, the sighting axis defined between the second adjustment member 132 and the housing is a flexure axis 150 (FIG. 12), which operates to adjust the elevation of the sight. Specifically, the second adjustment member 132 includes a flexure portion 148 disposed between the front end and the rear end of the second adjustment member 132. The flexure portion 148 defines a flexure axis 150 that extends transversely (laterally) across the second adjustment member 132, generally perpendicular to the longitudinal axis of the weapon when the sight is mounted. The flexure portion 148 comprises a region of reduced cross-sectional thickness (as shown in FIG. 13) that permits controlled elastic bending or flexing of the second adjustment member 132 about the flexure axis 150. The second adjustment member 132 is configured to receive force to drive movement of the second mounting portion about the flexure axis 150.

As shown in FIG. 13, the flexure portion 148 is a thinned section of the second adjustment member 132. The flexure portion 148 allows for controlled elastic deformation about the flexure axis 150, enabling fine-tuning of the sight's elevation alignment without requiring sliding or rotating mechanical joints that could introduce backlash or wear. The front end of the second adjustment member 132 is rigidly attached to the carrier base 114 of the housing 112 with fasteners (such as screws or bolts) that extend through the four mounting holes visible in FIG. 14. This rigid attachment ensures that the front end of the second adjustment member 132 moves with the carrier base 114 as a single unit. The rear end of the second adjustment member 132 includes a second adjuster 152 having a wedge 154 configured to engage with the housing at a spaced longitudinal distance on the weapon from the flexure axis 148. The second adjuster 152 includes a threaded shaft that is threadably engaged by the wedge 154 in an upward-facing slot defined in the second adjustment member 152. The rotation limits of the threaded shaft may define lateral movement limits of the wedge 154 in the slot, which thereby limits the vertical adjustment range β (FIG. 12) of the housing about the flexure axis 150. The second adjuster is configured to linearly move the wedge to drive vertical movement of the housing about the flexure axis, thereby defining the range of elevation adjustment.

The elevation adjustment mechanism operates with the second adjuster 152 at the rear end of the second adjustment member 132, which comprises a threaded shaft threadably engaged with a wedge 154. The wedge 154 has an inclined surface (ramp) that contacts a corresponding surface on the first adjustment member 130 or the weapon mounting interface. As the operator rotates the threaded shaft of the second adjuster 152, the wedge 154 moves laterally along the slot in the second adjustment member 132. The inclined surface of the wedge 154 converts this lateral motion into vertical displacement: as the wedge 154 moves in a direction that increases the effective thickness beneath the rear end of the second adjustment member 132, the rear end is pushed upward, causing the flexure portion 148 to bend and the front end (along with the attached carrier base 114) to rotate about the flexure axis 150 in a manner that raises the viewing window 118. Conversely, as the wedge 154 moves in a direction that decreases the effective thickness, the rear end drops and the front end rotates downward. The range of vertical motion is limited by the travel distance of the wedge 154 within its slot, which is in turn limited by the threaded engagement length of the second adjuster 152. These rotation limits define the vertical adjustment range β (FIG. 12) available for elevation adjustment. Importantly, because the front end of the second adjustment member 132 is attached to the carrier base 114, elevation adjustment moves the entire carrier base 114 (including both the optical component carrier 120 and the digital display device 124), maintaining their fixed spatial relationship.

Overall, the components of the adjustment assembly 128 are designed to facilitate precise alignment and positioning of the combined holographic and digital images within the viewing window. The exploded view provides a detailed look at the individual components that make up the adjustment assembly, highlighting their arrangement and interaction. It is also conceivable in additional examples that the wedge may be replaced with a different shape, such as a similar projection to the other adjuster, where the interfacing surface on the housing provides the ramped surface that imparts the vertical movement from the lateral movement driven by the second adjuster.

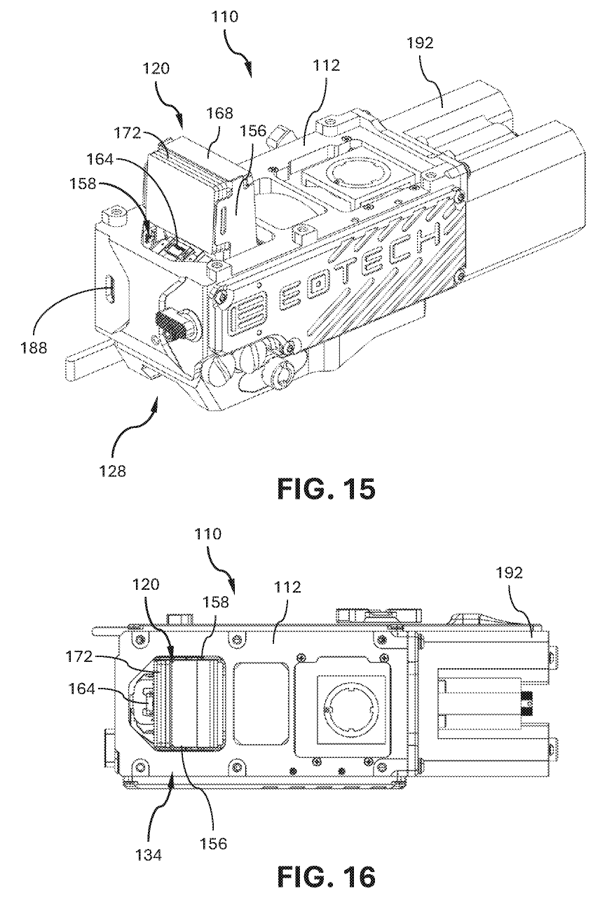

Referring now to FIGS. 15 and 16, the weapon sight 110 is shown with the frame 116 removed from the housing 112 to expose the opening that receives the optical component carrier 120 upon installation or assembly. This configuration highlights the internal components and their arrangement within the housing, providing insight into the integration of the holographic and digital display devices. The assembled optical component carrier 120 is lowered into the opening 158 in the upper portion of the housing on assembly. The carrier 120 is designed to hold optical components, such as the light source 164, mirror 168, and image hologram 172, which play a significant role in the creation and projection of the holographic reticle. The light source 164 emits light that interacts with the image hologram 172, producing the holographic image that is visible to the user.

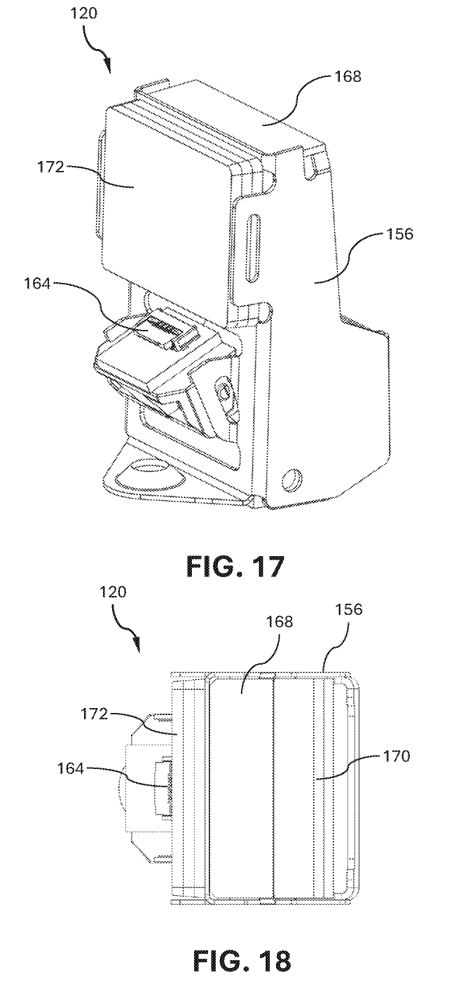

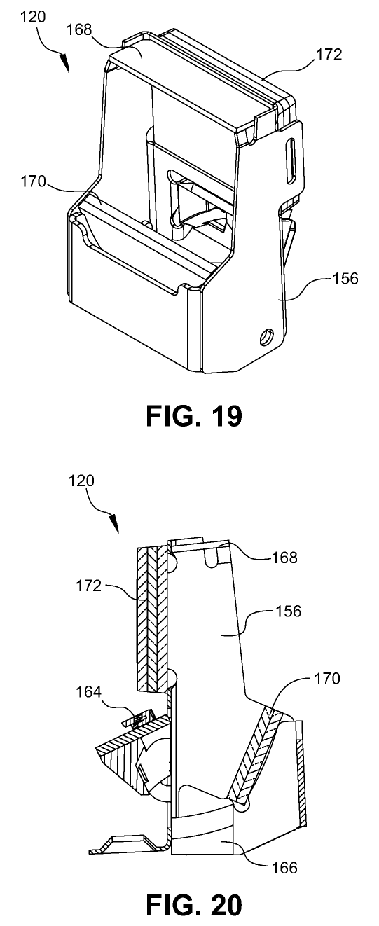

As shown in FIGS. 17-20, the optical component carrier 120 may include a chassis 156, constructed from a metal sheet, which offers a robust framework for the optical component carrier 120, ensuring that all optical elements are securely held in place. This chassis plays a significant role in maintaining the alignment and functionality of the optical components, contributing to the overall reliability and performance of the weapon sight 110.

The chassis 156 may be comprised of a metal sheet formed to support the plurality of optical components. The metal sheet of the chassis 156 may be formed to at least partially define an optical window that aligns with a viewing window of the housing 112 and a plurality of optical component receptacles for supporting the optical components. In some examples, the receptacles may be surfaces of the chassis 156 to which the optical components are adhered. The chassis 156 may include mating surfaces and/or walls that align each of the optical components with their respective receptacle. For example, the chassis 156 may include a plurality of fixed optical component receptacles for adhering the collimating optic 166, the mirror 168, the diffraction grating 170, and the image hologram 172 to the chassis 156. Mating surfaces and/or walls may dictate where the optical components are placed in the fixed optical component receptacles such that alignment of the optical components is provided based on their fixed location.

In examples, the collimating optic 166 may have a depth that is generally equal to the depth of the chassis 156, such that the ends of the collimating optic 166 align with the vertical walls of the chassis 156. Moreover, the collimating optic 166 additionally includes a parabolic surface that aligns with a parabolic bottom surface of the chassis 156 and a width generally equal to the width of the chassis 156. In this manner, the bottom surface and the vertical walls of the chassis assist with aligning the collimating optic 166 in the chassis 156 for proper alignment of the optical component. In another example, the mirror 168 similarly has a depth that is generally equal to the depth of the chassis 156, such that the ends of the mirror 168 align with the vertical walls of the chassis 156. Moreover, the chassis 156 includes an upper surface upon which the planar surface of the mirror 168 aligns with and has a width that is generally equal to the width of the mirror 168. Thus, the upper surface and the vertical walls, second vertical wall of the chassis 156 assist with aligning the mirror 168. The diffraction grating 170 has a width that is generally equal to the width of the chassis 156. The chassis 156, as shown in FIG. 20, includes an angled surface configured such that the diffraction grating 170 rests against the angled surface, such that the angled surface assists with aligning the diffraction grating 170. The image hologram 172 includes a width that is generally equal to the width of the chassis 156. The upper surface of the image hologram 172 may be aligned with the upper surface of the chassis 156 to assist with aligning the image hologram 172. In this manner, the surfaces of the chassis 156 assist with aligning the collimating optic 166, the mirror 168, the diffraction grating 170, and the image hologram 172 such that the optical elements are properly aligned to provide the correct optical path between each of the optical elements. Each of the optical elements may be secured and/or adhered to their respective fixed optical component receptacles.

Once the fixed optical component receptacles are secured with their respective optical elements, the light source 164 may be aligned and attached to the chassis 156. The chassis 156 may include an adjustable optical component receptacle for adhering the light source 164 to the chassis 156. In an example, the adjustable optical component receptacle may include a first receptacle part (i.e., a carrier 120) and a second receptacle part (i.e., a control board 136). The first receptacle part 120 may be configured to allow for adjustment of the light source in at least a first and second direction, and the second receptacle part may be configured to allow for adjustment of the light source in at least a third direction. The carrier 120 for the light source 164 may be provided in the adjustable optical component receptacle, which allows for adjustment of the position of the carrier 120 prior to adhering and fixing the carrier 120 in place. As such, the carrier 120 may be adjusted to properly align the light source 164 with the other optical components, and in particular the collimating optic 166, prior to the carrier 120 being fixed in position relative to the chassis 156. The adjustable optical component receptacle may include a receptacle aperture for receiving a carrier fastener that extends along a carrier axis. The receptacle aperture may be configured to receive the carrier fastener and allow adjustment of the position of the carrier 120 via the carrier fastener in the receptacle aperture in at least one of a linear direction in the receptacle aperture and a pivotable direction about the carrier axis. The control board for the light source 164 is a planar member that is positionable on a planar surface of the carrier 120, allowing planar movement of the light source 164 relative to the carrier 120. Thus, the light source 164 is provided with at least a first and second degree of movement via the carrier 120 and at least a third degree of movement via the control board. In this manner, the light source 164 may be properly aligned with the collimating optic 166 and the remaining optical components prior to fixing the location of the light source during manufacturing of the optical component carrier 120. Once aligned, the chassis 156 and the control board may be adhered to a fixed position relative to the chassis 156 to remain aligned with the other optical components to maintain the optical path illuminating the holographic image.

Once all optical components (i.e., the light source 164, the collimating optic 166, the mirror 168, the diffraction grating 170, and the image hologram 172) are aligned, the optical path travels from the light source 164, reflecting the beam off each optical component to the rear window to illuminate the holographic image in the viewing window defined by the chassis 156 and the housing 112 for the operator to see through the rear window.

The housing 112 is constructed to endure environmental factors while preserving the alignment and functionality of the sight. The housing 112 may be fabricated from materials such as aluminum alloy, polymer composites, or other durable materials suitable for weapon-mounted applications. The housing 112 provides environmental sealing to protect the internal optical components from dust, moisture, and other contaminants. Seals may be provided at the front and rear windows of the viewing window 118, at the interface between the frame 116 and the carrier base 114, at the battery module 192 interface, and at penetrations for controls (knobs 184, 186, switch 190, port 188). The housing 112 may meet environmental protection standards such as IP67 (protection against dust ingress and temporary water immersion) or military standards such as MIL-STD-810 (environmental testing for military equipment). The housing 112 is also designed to withstand mechanical shock and vibration associated with weapon recoil and handling, maintaining optical alignment and functionality under these dynamic loading conditions.

As shown in FIGS. 1-7 and FIG. 21, the weapon sight 110 includes a battery module 192 that provides electrical power to the light source 164, the digital display device 124 (including the imager 174), and associated electronic control circuitry. The battery module 192 is configured to be removably attached to the housing 112, allowing the operator to replace or recharge the battery module 192 as needed. In one implementation, the battery module 192 includes one or more rechargeable lithium-ion battery cells. The battery module 192 may include a battery management system that monitors battery charge level, controls charging processes when external power is applied via the connection ports 194, and provides battery status information to the electronic controller for display to the operator (e.g., via the digital display device 124 or via dedicated status indicators). The connection ports 194 on the battery module 192 may provide electrical connections for charging the battery, for powering external accessories (such as weapon-mounted lights, lasers, or other sighting devices), and/or for data communication with external devices. The battery module 192 may be secured to the housing 112 via a latch, clamp, threaded connection, or other releasable attachment mechanism that provides secure retention during weapon use while allowing tool-free removal for battery replacement or charging.

The carrier base 114 plays a significant role in the weapon sight 110, permitting movement around a sighting axis. This movement is necessary for the precise alignment of the holographic reticle and digital display, ensuring that the combined image remains accurate and reliable during operation. The carrier base 114 supports both the optical component carrier and the digital display device, facilitating the integration of the two imaging systems. The frame 116 partially defines a viewing window through which the operator can view the combined image. This frame 116 is designed to provide a clear and unobstructed field of view, allowing the operator to quickly acquire and engage targets. The integration of the holographic reticle and digital display within the same viewing window enhances situational awareness by overlaying important information directly onto the target area.

Thus, according to the disclosure, a weapon sight includes a housing, an optical component carrier, and a digital display device, and an adjustment assembly. The housing is configured to mount to a weapon and includes a carrier base configured to move about a sighting axis and a frame that at least partially defines a viewing window. The optical component carrier is coupled to the carrier base for illuminating a holographic image that is visible through the viewing window. The digital display device is at least partially coupled to the carrier base for displaying a digital image that is visible through the viewing window. The holographic image and the digital image may form a combined image, wherein the holographic image is fixed relative to the digital image. The adjustment assembly may include a first adjustment member and a second adjustment member configured for positional adjustment of the combined image in the viewing window. At least one of the first adjustment member and the second adjustment member may be configured to receive a force to drive movement of the carrier base about the sighting axis.

Also, according to the disclosure, a weapon sight may include a housing configured to mount to a weapon, an optical component carrier, and a digital display device. The housing may be configured to mount to a weapon and may define a viewing window and include a base that is fixedly adjustable relative to the housing. The optical component carrier may be coupled to the base and may form a first optical path for illuminating a holographic image in the viewing window. The digital display device may be coupled to the base and may form a second optical path for displaying a digital image in the viewing window. The adjustment member may be coupled to the base and be configured to move the base relative to the housing about a sighting axis. The adjustment member may be configured to move the first optical path and the second optical path to maintain a fixed position of the holographic image relative to the digital image.

In summary, the weapon sight 110 described herein provides integrated holographic and digital imaging capabilities through a unified structural design in which both optical systems are rigidly mounted to a common carrier base 114. This integration provides several key advantages: (1) the holographic image 122 and digital image 126 maintain a fixed spatial relationship that does not vary with environmental conditions, weapon recoil, or sight adjustments; (2) windage and elevation adjustments via the adjustment assembly 128 move both optical systems simultaneously, ensuring that the holographic reticle and digital information remain aligned during the zeroing process; (3) both optical paths converge at the viewing window 118 to present images at a common focal plane, eliminating parallax errors; and (4) the integrated design simplifies manufacturing, reduces weight and volume compared to separately mounted devices, and improves overall reliability and durability. These features make the weapon sight 110 particularly suitable for demanding military, law enforcement, and civilian applications where accurate, reliable, and information-rich targeting capabilities are required.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature; may be achieved with the two components (electrical or mechanical) and any additional intermediate members being integrally formed as a single unitary body with one another or with the two components; and may be permanent in nature or may be removable or releasable in nature, unless otherwise stated.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote one element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A weapon sight, comprising:
a housing having a base configured to be adjustably mounted to a weapon;
an optical component carrier fixedly attached to the housing for illuminating a holographic image that is visible through a viewing window disposed over the base;
a digital display device fixedly attached to the housing for displaying a digital image that is visible through the viewing window simultaneously with the holographic image; and
an adjustment assembly configured to be coupled between the base and the weapon, the adjustment assembly having a first adjustment member and a second adjustment member operable for positional adjustment of the housing about a sighting axis;
wherein movement of the housing about the sighting axis relative to the weapon via at least one of the first adjustment member and the second adjustment member simultaneously moves both the optical component carrier and the digital display device to maintain a fixed spatial relationship between the holographic image and the digital image.

2. The weapon sight of claim 1, wherein the base of the housing includes a first mounting portion configured to support the optical component carrier and a second mounting portion configured to support the digital display device.

3. The weapon sight of claim 2, wherein the sighting axis includes a rotational axis and the first adjustment member is configured to receive force to drive movement of the housing about the rotational axis relative to the weapon.

4. The weapon sight of claim 3, wherein the first adjustment member is coupled to the housing by a fastener defining the rotational axis, and wherein the first adjustment member includes a linear adjustment mechanism engaged with the housing at a spaced distance from the rotational axis and operable to drive movement tangential to the rotational axis to impart rotational movement of the housing about the rotational axis.

5. The weapon sight of claim 2, wherein the second adjustment member includes a flexure portion disposed between opposing end portions of the second adjustment member, and wherein the flexure portion defines a flexure axis.

6. The weapon sight of claim 5, wherein the sighting axis includes the flexure axis and the second adjustment member is configured to receive force to drive movement of the second mounting portion about the flexure axis.

7. The weapon sight of claim 6, wherein a first end portion of the second adjustment member is attached to the housing with fasteners, and wherein a second end portion of the second adjustment member includes an elevation adjustment mechanism at a spaced distance from the flexure axis and operable to drive vertical movement of the housing about the flexure axis.

8. The weapon sight of claim 1, wherein the optical component carrier includes a rigid chassis defining an optical window and a plurality of mating surfaces configured to support optical components for illuminating the holographic image in the optical window, and wherein the optical window is aligned with the viewing window of the housing.

9. The weapon sight of claim 8, wherein the optical components include a light source, a collimating optic, a mirror, a diffraction grating, and an image hologram.

10. The weapon sight of claim 1, wherein the digital display device includes a display, a mirror, and a beam splitter for displaying the digital image in the viewing window.

11. The weapon sight of claim 1, wherein the holographic image and digital image share a common optical axis that remains substantially fixed upon movement of the housing about the sighting axis.

12. A weapon sight, comprising:
a housing having a base configured to mount to a receiver of a weapon;
a frame disposed above the base of the housing and defining a viewing window;
an optical component carrier coupled to the housing and fixedly supporting a plurality of optical components that are operable to illuminate a holographic image visible through the viewing window along a first optical path;
a digital display device coupled to the housing and operable to display a digital image visible through the viewing window along a second optical path, wherein the holographic image and the digital image are simultaneously visible in the viewing window; and
an adjustment assembly coupled to the housing and configured to adjustably move the housing relative to the weapon about a sighting axis defined by the adjustment assembly,
wherein the first optical path and the second optical path remain fixed relative to each other when adjustably moving the housing about the sighting axis relative to the weapon.

13. The weapon sight of claim 12, wherein the base of the housing comprises a monolithic structure to which both the optical component carrier and the digital display device are directly attached.

14. The weapon sight of claim 13, wherein the adjustment assembly is configured for positional adjustment of both the holographic image and the digital image in unison within the viewing window to sight the weapon sight on the weapon.

15. The weapon sight of claim 12, wherein the adjustment assembly comprises an elevation adjustment member and a windage adjustment member that are operable for positional adjustment of the housing to simultaneously adjust the holographic image and the digital image relative to the weapon.

16. The weapon sight of claim 12, wherein the optical component carrier includes a chassis comprised of a metal sheet and formed to at least partially define an optical window aligned with the viewing window and a plurality of mating surfaces configured to support a plurality of optical components for illuminating the holographic image.

17. The weapon sight of claim 12, wherein the digital display device includes at least a display and a beam splitter for providing the digital image in the viewing window.

18. The weapon sight of claim 12, wherein the base includes a first mounting portion supporting the optical component carrier and a second mounting portion supporting the digital display device.

19. The weapon sight of claim 18, wherein the adjustment assembly includes a fastener extending through the first mounting portion forming the sighting axis, the adjustment assembly configured to receive a force to drive rotational movement of the housing about the sighting axis.

20. The weapon sight of claim 18, wherein the adjustment assembly includes a flexure axis between the first mounting portion and the second mounting portion forming the sighting axis, the adjustment assembly configured to receive a force to drive movement of the housing about the sighting axis.
